(19) United States
(12) Patent Application Publication
(10) Pub. No.: US 2007/0132565 A1
(43) Pub. Date: Jun. 14, 2007

(54) Collision load detection device and collision obstacle discrimination device using the same

(75) Inventor: Takatoshi Tanabe, Ichinomiya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (KR)

(21) Appl. No.: 11/636,788

(22) Filed: Dec. 11, 2006

(30) Foreign Application Priority Data
Dec. 14, 2005 (JP) 2005-360894

(51) Int. Cl. B60Q 1/00; E05F 15/00

(52) U.S. Cl. 340/436; 701/45

(57) ABSTRACT

A collision load detection device for a vehicle is provided with first-type load detection members and second-type load detection members. The first-type load detection member and the second-type load detection member respectively have different sensitivity properties from each other. The signal detected in the high sensitivity field is selected from the signal outputted by the first-type load detection member and that outputted by the second-type load detection member, to be used for the calculation of the collision load applied to the vehicle.

### CROSS REFERENCE TO RELATED APPLICATION

This application is based on a Japanese Patent Application No. 2005-360894 filed on Dec. 14, 2005, the disclosure of which is incorporated herein by reference.

### FIELD OF THE INVENTION

The present invention relates to a collision load detection device and a collision obstacle discrimination device using the same. The collision load detection device and the collision obstacle discrimination device can be suitably used for a vehicle, for example.

### BACKGROUND OF THE INVENTION

Various devices have been proposed to detect a collision load applied to a vehicle when the vehicle collides with an obstacle. For example, as disclosed in JP-2005-214824A, an optical fiber sensor device is provided. In this case, the optical fiber sensor device has an optical fiber, a light-entering portion for entering light signal to one end of the optical fiber, and a light-receiving portion for receiving the light signal at the other end of the optical fiber. The collision load is detected according to a variation of the optical signal received by the light-receiving portion.

Moreover, as disclosed in JP-2006-232027A (U.S. Ser. No. 11/351,501) which has the same inventor with the present application, the collision load is detected by a mat-type pressure sensitive sensor which has sensor cells of one type. In this case, based on the detected collision load, the collision obstacle is sort-discriminated (that is, it is determined whether or not collision obstacle is a pedestrian).

The load sensor such as the optical fiber and the sensor cell for detecting the collision load is mounted in the vicinity of a vehicle front surface (e.g., front bumper, bumper reinforcement member and the like), so as to detect the collision load applied to the vicinity of the vehicle front surface when the vehicle collides with the obstacle.

Because the weight of the obstacle (e.g., weight of pedestrian) which may collide with the vehicle is various and the vehicle velocity is various at the time of the collision occurrence between the vehicle and the obstacle, the value of the collision load applied to the vehicle has an extensive range. Therefore, it is desirable that the load sensor detects the collision load with a satisfactory accuracy over an extensive load range.

However, generally, it is difficult for the load sensor to detect the collision load with a satisfactory accuracy over the extensive load range. FIG. 10 shows the sensitivity property of a pressure-sensitive sensor cell as an example of a load sensor. Referring to FIG. 10, the load sensor has the sensitivity property including a high sensitivity field and a low sensitivity field. In the high sensitivity field, the load sensor has a predetermined detection sensitivity in response to a variation of the collision load applied thereto (which is detected as pressure in the example shown in FIG. 10). In the low sensitivity field, the load sensor has a lower detection sensitivity than that in the high sensitivity field.

Thus, in the case where it is necessary to detect the collision load over the extensive load range (e.g., in the case of collision load detection device for vehicle), the extensive load range is covered by not only the high sensitivity field but also the low sensitivity field of the load sensor. Therefore, there exists a field of a low detection accuracy, in the load range which is required to be detected.

For example, in the case of JP-2005-47458A where the sensor cell is used as the load sensor, the width of the high sensitivity field of the sensor cell is almost determined when a minimum detectable load is set as a predetermined value, due to the construction of the load sensor. Therefore, it is difficult to cover the extensive load range only by the high sensitivity field set as above-described, when the minimum detection load required for the collision load detection device for the vehicle is set as the minimum detection load of the sensor cell. Therefore, there exists a field of a low detection accuracy, in the above-described extensive load range.

Furthermore, in the case where the collision obstacle is sort-discriminated based on the collision load detected with the low detection accuracy, the discrimination accuracy will be deteriorated.

### SUMMARY OF THE INVENTION

In view of the above-described disadvantages, it is an object of the present invention to provide a collision load detection device which detects a collision load with a satisfactory accuracy in the whole load range required to be detected, and a collision obstacle discrimination device using the same which substantially sort-discriminates a collision obstacle.

According to a first aspect of the present invention, a collision load detection device for a vehicle has a plurality of load detection members for detecting a collision load applied to the vehicle due to a collision between the vehicle and an obstacle and outputting signals corresponding to the detected collision load, and a controller for calculating the collision load in a predetermined load range based on the signals. A sensitivity property of the load detection member includes a high sensitivity field in which the load detection member has a predetermined detection sensitivity in response to a variation of the collision load applied thereto, and a low sensitivity field in which the load detection member has a lower detection sensitivity than that of the high sensitivity field. At least one of the plurality of load detection members has the sensitivity property different from that of the other of load detection members. The predetermined load range is complementarily all-inclusive in the high sensitivity fields of the load detection members which have the different sensitivity properties. The controller selectively uses the signals detected in the high sensitivity field from the signals outputted by the plurality of load detection members, to calculate the collision load in the predetermined load range.

Thus, the collision load can be calculated based on the signals which are detected in the high sensitivity field, in the whole predetermined load range which is required to be detected. Accordingly, the collision load detection device can measure the collision load with an improved accuracy in the whole predetermined load range.

According to a second aspect of the present invention, a collision load detection device for detecting a collision load applied to a vehicle due to a collision between the vehicle and an obstacle is provided with a first load detection member which has a high detection sensitivity when the collision load applied to the first load detection member is low and which outputs a first signal in response to the collision load, a second load detection member which has a high detection sensitivity when the collision load applied to the second load detection member is high and which outputs a second signal in response to the collision load, and a controller which selectively uses the first signal and the second signal to calculate the collision load.

Thus, the collision load can be calculated by selecting the signals detected with the high sensitivity. Therefore, the collision load can be measured with an improved accuracy, over an extensive load range.

Preferably, the load detection member is a pressure-sensitive sensor cell, and the plurality of sensor cells construct a mat-type pressure sensitive sensor.

The sensitivity property of the pressure-sensitive sensor cell can be readily modified by changing the size and material of the components which construct the sensor cell. Therefore, the load detection members having the different sensitivity properties can be readily prepared. Moreover, the mat-type pressure sensitive sensor which is constructed of the sensor cells can be readily mounted to the vehicle as compared with the case where the multiple sensor cells are separately handled.

According to a third aspect of the present invention, a collision obstacle discrimination device is provided with the collision load detection device as described above. The controller further sort-discriminates the obstacle, based on a detection result of the collision load detection device.

Because the collision load detection device can measure the collision load with an improved accuracy in the whole predetermined load range, the sort discrimination accuracy can be also improved.

### BRIEF DESCRIPTION OF THE DRAWINGS

Other objects, features and advantages of the present invention will become more apparent from the following detailed description made with reference to the accompanying drawings, in which:

FIG. 1 is a perspective view showing a vehicle according to a preferred embodiment of the present invention;

FIG. 2 is schematic partially-sectional view showing the vicinity of a bumper of the vehicle in perspective view from an upper side of the vehicle according to the preferred embodiment;

FIG. 3 is a schematic partially-sectional view showing the bumper in perspective view from a direction of an arrow III in FIG. 2;

FIG. 4 is a schematic partially-sectional view showing the vehicle in perspective view from a direction of an arrow IV in FIG. 2;

FIG. 5 is a plan view showing a construction of a mat-typed pressure sensitive sensor according to the preferred embodiment;

FIG. 6A is a cross sectional view which shows the mat-typed pressure sensitive sensor and is taken along a line VIA-VIA in FIG. 5, and FIG. 6B is a cross sectional view which shows the mat-typed pressure sensitive sensor and is taken along a line VIB-VIB in FIG. 5;

FIG. 7 is a block diagram showing a construction of a collision obstacle discrimination device according to the preferred embodiment;

FIG. 8 is a graph showing a sensitivity property of a pressure-sensitive sensor cell according to the preferred embodiment;

FIG. 9 is a flow chart showing an operation of a signal selection unit according to the preferred embodiment; and

FIG. 10 is a graph showing a sensitivity property of a pressure-sensitive sensor cell according to a related art.

### DETAILED DESCRIPTION OF THE EXAMPLED EMBODIMENTS

### Preferred Embodiment

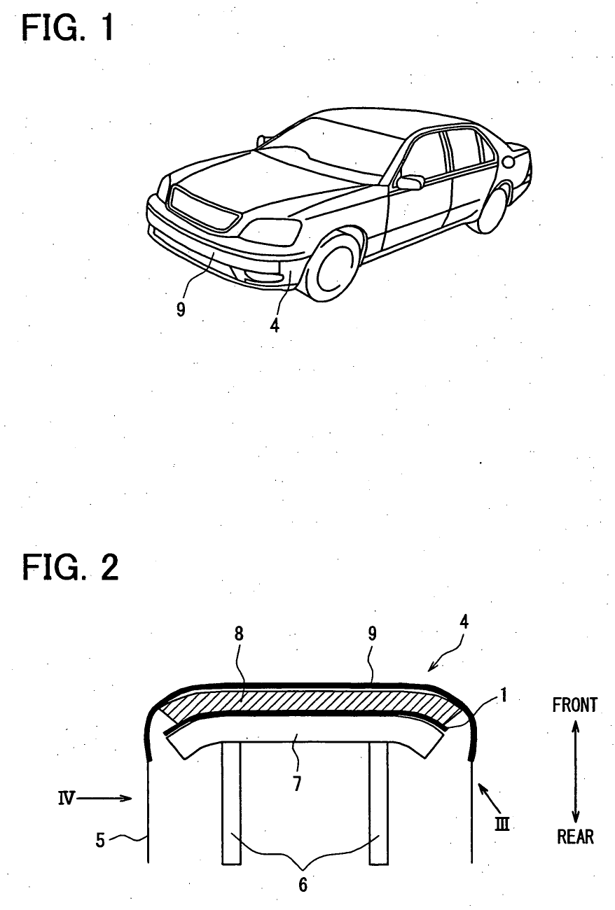

A collision load detection device according to a preferred embodiment of the present invention will be described with reference to FIGS. 1-9. The collision load detection device can be suitably used for a vehicle, for example.

As shown in FIG. 1, the vehicle has a bumper cover 9 which is mounted to the front surface of a bumper 4 (e.g., front bumper). With reference to FIGS. 2-4, the vehicle has a pair of side members 6 which extend in the vehicle front-rear direction and are respectively arranged at the vehicle right side and the vehicle left side.

The bumper 4 includes a bumper reinforcement member 7 which extends in the vehicle left-right direction (i.e., vehicle width direction) and is mounted to the front ends of the side members 6. The side members 6 and the reinforcement member 7 can be made of metal to construct a framework of the vehicle. A bumper absorber 8 of the bumper 4 is made of an elastic material such as a foam resin, and arranged at the front surface of the reinforcement member 7. The bumper cover 9 extends in the vehicle left-right direction to cover the bumper absorber 8.

The collision load detection device has at least one mat-type pressure sensitive sensor 1. The mat-type pressure sensitive sensor 1 has a substantially linear shape (i.e., band shape) on the whole, and is arranged along the reinforcement member 7 to extend in the vehicle left-right direction. In this case, the mat-type pressure sensitive sensor 1 can be sandwiched between the reinforcement member 7 and the bumper absorber 8.

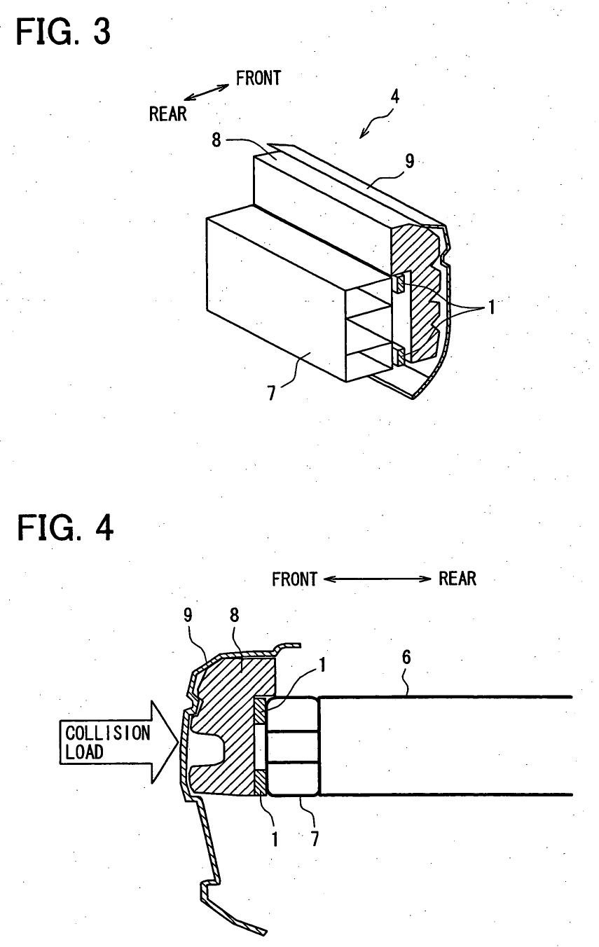

Referring to FIGS. 3 and 4, the two mat-type pressure sensitive sensors 1 can be mounted to the front surface of the reinforcement member 7, and respectively positioned at the upper portion of the front surface and the lower portion of the front surface.

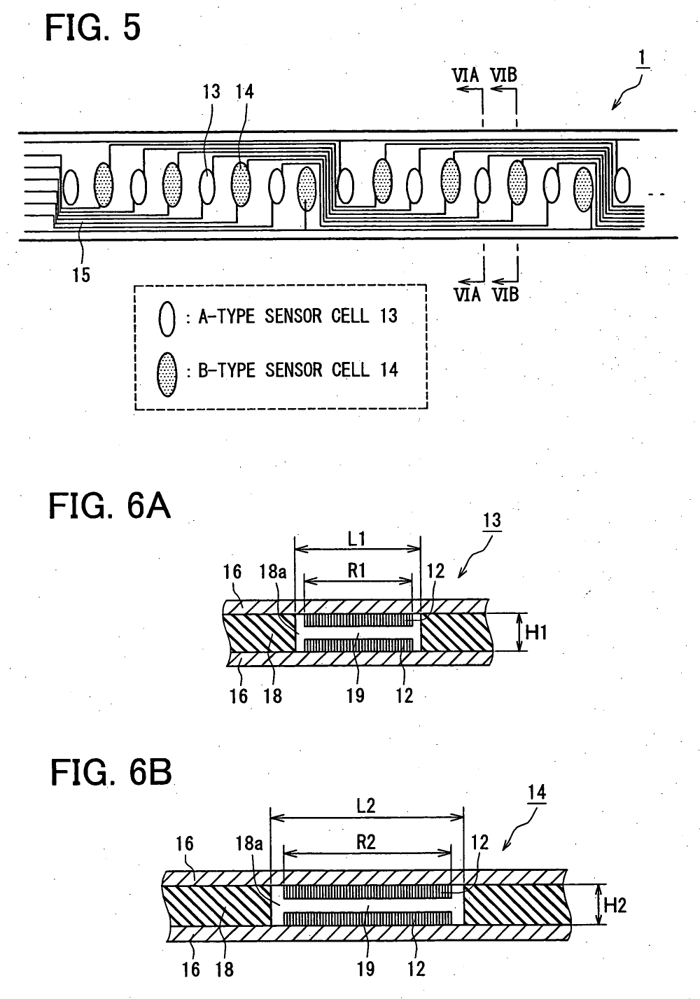

FIG. 5 is a plan view showing the construction of the mat-type pressure sensitive sensor 1. The mat-type pressure sensitive sensor 1 can have two types of sensor cells (load detection members), that is, A-type sensor cells 13 and B-type sensor cells 14. The multiple A-type sensor cells 13 and the multiple B-type sensor cells 14 are alternately disposed in the vehicle left-right direction and positioned in the vicinity of each other, in such a manner that all of the multiple A-type sensor cells 13 and the multiple B-type sensor cells 14 are arrayed substantially linearly on the whole.

That is, the adjacent two B-type sensor cells 14 are separated from each other by the A-type sensor cell 13. Similarly, the adjacent two A-type sensor cells 13 are separated from each other by the B-type sensor cell 14.

Each of the multiple A-type sensor cells 13 and the multiple B-type sensor cells 14 is connected with a wiring 15.

Next, the interior construction and the load detecting manner of the mat-type pressure sensitive sensor 1 will be described with reference to FIGS. 6A and 6B which respectively show the A-type sensor cell 13 and the B-type sensor cell 14. In FIGS. 6A and 6B, the wirings 15 are not shown.

At first, the common construction of the A-type sensor cell 13 and the B-type sensor cell 14 will be described.

As shown in FIGS. 6A and 6B, the mat-type pressure sensitive sensor 1 has a pair of resin films 16 and a spacer film 18 (not shown in FIG. 5), which is inserted between the resin films 16 and fixed to the resin films 16 by bonding through adhesive or adhering layer (not shown), for example. The resin film 16 has an elongated shape. The resin film 16 and the spacer film 18 can be constructed of resin, for example, PEN (Polyethylene naphtahalate).

The pair of resin films 16 are arranged to face each other. Each of the resin films 16 is provided with multiple pressure sensitive ink layers 12, which are electrically conductive and fixed to the inner surface thereof. The multiple pressure sensitive ink layers 12 of each of the resin films 16 are arrayed with a predetermined pitch. The pressure sensitive ink layer 12 is provided with a predetermined electrical resistance, and has a substantially circular shape in a plan view (viewed in vehicle front-rear direction), for example.

In this case, the spacer film 18 has multiple openings 18a (through holes), each of which has a substantially circular shape in the plan view (viewed in vehicle front-rear direction), for example. The openings 18a are arrayed with the same predetermined pitch with that of the pressure sensitive ink layers 12. Moreover, the number of the openings 18a is the same with that of the pressure sensitive ink layers 12 of each of the resin films 16.

Thus, in the each opening 18a, a pair of the pressure sensitive ink layers 12 are arranged. The pair of the pressure sensitive ink layers 12 are respectively fixed to the resin films 16 to face each other with an inner space 19 therebetween. The height of the inner space 19 is determined by the thickness of the spacer film 18.

That is, each of the A-type sensor cells 13 and the B-type sensor cells 14 is provided with the two pressure sensitive ink layers 12, which are respectively fixed to the resin film 16 of the vehicle front side and the resin film 16 of the vehicle rear side to face each other with the inner space 19 therebetween. The pair of the pressure sensitive ink layers 12 are respectively connected with the wirings 15 as shown in FIG. 5.

Next, the difference between the A-type sensor cell 13 and the B-type sensor cell 14 will be described. According to this embodiment, a diameter L1 of the opening 18a of the spacer film 18 of the A-type sensor cell 13 is smaller than a diameter L2 of the opening 18a of the spacer film 18 of the B-type sensor cell 14.

Moreover, a diameter R1 of the pressure sensitive ink layer 12 of the A-type sensor cell 13 is smaller than a diameter R2 of the pressure sensitive ink layer 12 of the B-type sensor cell 14. In this case, a thickness H1 of the spacer film 18 of the A-type sensor cell 13 can be substantially equal to a thickness H2 of the spacer film 18 of the B-type sensor cell 14.

A predetermined potential difference is provided between the pair of the pressure sensitive ink layers 12 (which face each other) of the sensor cell 13, 14, through the wirings 15. The electrical resistance between the pair of the pressure sensitive ink layers 12 is detected by a microcomputer (not shown) or the like of the mat-type pressure sensitive sensor 1.

In this case, when a collision load (for example, toward vehicle rear side as shown in FIG. 4) exceeding a predetermined value is applied to the resin film 16 of the vehicle front side, the resin films 16 and the pressure sensitive ink layers 12 are deformed (for example, bent) to be compressed in the thickness direction of the mat-type pressure sensitive sensor 1.

Thus, in the case where the collision load is larger than a predetermined value, the pair of pressure sensitive ink layers 12 which are arranged in the same opening 18a contact each other. The contact area between the pair of pressure sensitive ink layers 12 will increase in response to the collision load which is applied to the resin film 16, when the value of the collision load is within a predetermined range (i.e., high sensitivity field described later).

Thus, the electrical resistance between the pair of pressure sensitive ink layers 12 will decrease corresponding to the applied collision load. Therefore, it can be detected at which sensor cell 13, 14 the collision load is applied and how much the collision load is applied, by sequentially detecting the electrical resistances of the multiple sensor cells 13 and 14 of the mat-type pressure sensitive sensor 1.

However, in the case where the collision load applied to the resin film 16 exceeds the predetermined range, that is, the collision load is in a low sensitivity field, the pair of pressure sensitive ink layers 12 will contact each other at the most parts thereof. Then, when the larger collision load is exerted to the resin film 16, the contact area between the pair of pressure sensitive ink layers 12 will not increase.

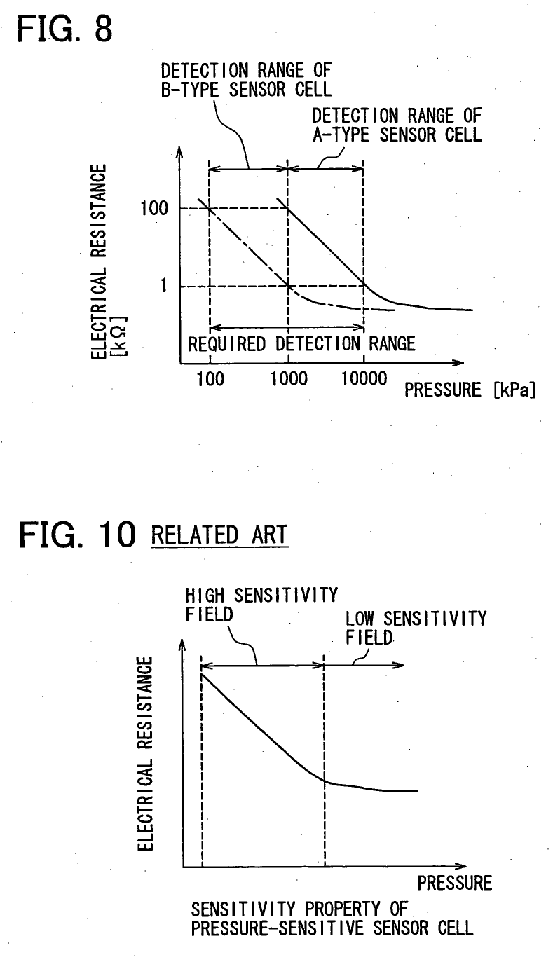

As described above, because the construction of the A-type sensor cell 13 is different from that of the B-type sensor cell 14, the resin film 16 and the pressure sensitive ink layer 12 of the A-type sensor cell 13 are more difficultly deformed than the resin film 16 and the pressure sensitive ink layer 12 of the B-type sensor cell 14 do. Thus, as shown in FIG. 8, the sensitivity property of the A-type sensor cell 13 is different from that of the B-type sensor cell 14. Each of the horizontal axis and the vertical axis in FIG. 8 has a log scale. In FIG. 8, the sensitivity property of the A-type sensor cell 13 is indicated by a solid line and the sensitivity property of the B-type sensor cell 14 is indicated by a broken line.

Specifically, the sensitivity property of the A-type sensor cell 13 includes a high sensitivity field where the A-type sensor cell 13 has a relatively high detection sensitivity, and a low sensitivity field where the A-type sensor cell 13 has a relatively low detection sensitivity.

When the pressure applied to the A-type sensor cell 13 is within a range from about 1000 kPa to about 10000 kPa, the A-type sensor cell 13 is in the high sensitivity field. That is, the electrical resistance of the A-type sensor cell 13 has a large variation in response to the variation of the pressure applied to the A-type sensor cell 13.

When the pressure applied to the A-type sensor cell 13 is larger than or equal to about 10000 kPa, the A-type sensor cell 13 is in the low sensitivity field. That is, the electrical resistance of the A-type sensor cell 13 has a small variation in response to the variation of the pressure applied to the A-type sensor cell 13.

The sensitivity property of the B-type sensor cell 14 includes a high sensitivity field where the B-type sensor cell 14 has a relatively high detection sensitivity, and a low sensitivity field where the B-type sensor cell 14 has a relatively low detection sensitivity.

When the pressure applied to the B-type sensor cell 14 is within a range from about 100 kPa to about 1000 kPa, the B-type sensor cell 14 is in the high sensitivity field. That is, the electrical resistance of the B-type sensor cell 14 has a large variation in response to the variation of the pressure applied to the B-type sensor cell 14.

When the pressure applied to the B-type sensor cell 14 is larger than or equal to about 1000 kPa, the B-type sensor cell 14 is in the low sensitivity field. That is, the electrical resistance of the B-type sensor cell 14 has a small variation in response to the variation of the pressure applied to the B-type sensor cell 14.

In order to determine whether or not an obstacle colliding with the vehicle is a human (e.g., pedestrian), the pressure range (required detection range) to be detected by the mat-type pressure sensitive sensor 1 is from about 100 kPa to about 10000 kPa. As described above, with reference to FIG. 8, this required detection range is complementarily covered by the high sensitivity field of the A-type sensor cell 13 and that of the B-type sensor cell 14. That is, this range is complementarily all-inclusive in the high sensitivity field of the A-type sensor cell 13 and that of the B-type sensor cell 14.

The mat-type pressure sensitive sensor 1 respectively sends the detection result of the A-type sensor cell 13 and that of the B-type sensor cell 14 to a controller 3, irrespectively to the sensitivity field in which the result is detected by the sensor cell 14, 13.

Next, a collision obstacle discrimination device 10 and a pedestrian protection device 21 which is connected with the collision obstacle discrimination device 10 will be described.

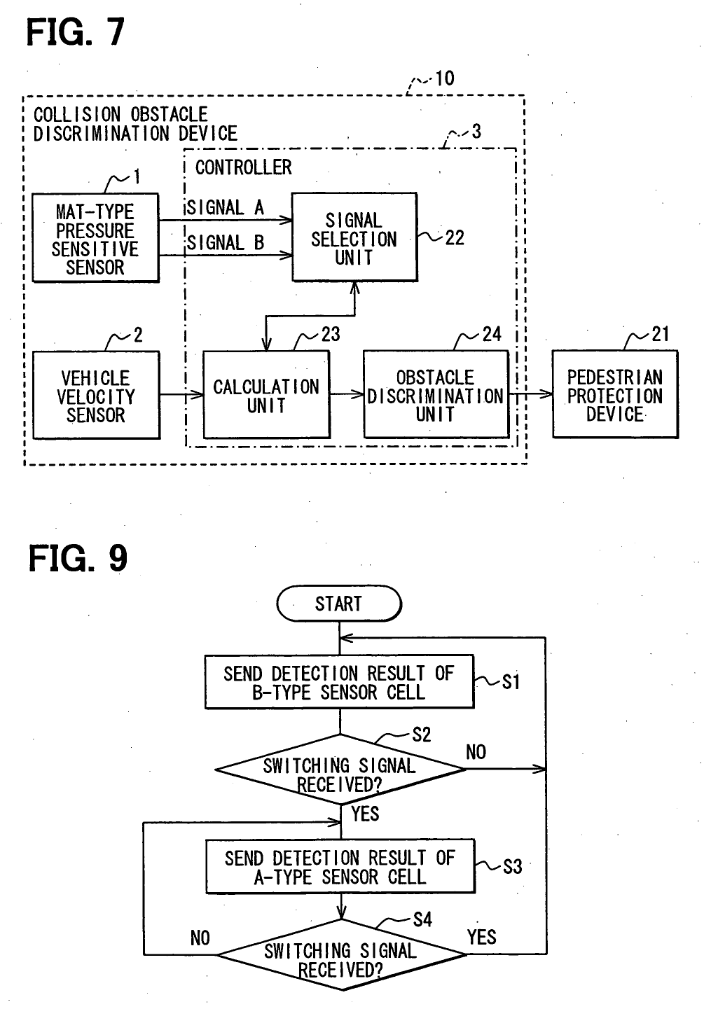

As shown in FIG. 7, the collision obstacle discrimination device 10 includes the mat-type pressure sensitive sensor 1, a vehicle velocity sensor 2 and the controller 3, which is connected with the pedestrian protection device 21 through a signal line.

In this case, the vehicle velocity sensor 2 can be a well-known sensor for detecting the velocity of the vehicle. The controller 3 can be constructed of a signal processing circuit in which a microcomputer is embedded. The controller 3 has a signal selection unit 22, a calculation unit 23 and an obstacle discrimination unit 24, to determine whether or not the obstacle colliding with the vehicle is a pedestrian based on the output signal of the mat-type pressure sensitive sensor 1 and that of the vehicle velocity sensor 2.

The pedestrian protection device 21 includes, for example, an airbag apparatus (not shown) for deploying an airbag on a hood of the vehicle, and/or a hood lifting apparatus for lifting the hood, and the like. In the case where it is determined that the obstacle colliding with the vehicle is the pedestrian, the pedestrian protection device 21 will be actuated to protect the pedestrian.

Next, the operation of the collision obstacle discrimination device 10 will be described with reference to FIG. 9 which shows the operation of the signal selection unit 22.

When an ignition (start) switch (not shown) of the vehicle becomes ON, the mat-type pressure sensitive sensor 1 sends the detection result of the A-type sensor cell 13 and that of the B-type sensor cell 14 to the signal selection unit 22 of the controller 3.

Moreover, the vehicle velocity sensor 2 sends the signal of the velocity of the vehicle to the calculation unit 23 of the controller 3.

The signal selection unit 22 can be provided with an initial setting in such a manner that the detection result of the B-type sensor cell 14 is selected (by signal selection unit 22 from detection results having sent by the mat-type pressure sensitive sensor 1) to be used as the signal which will be sent to the calculation unit 23. Thus, with reference to FIG. 9, at step S1, the signal selection unit 22 sends the detection result of the B-type sensor cell 14 to the calculation unit 23.

The calculation unit 23 calculates the collision load based on the detection result having sent by the signal selection unit 22. In the case where the collision of the vehicle does not occur, the calculated collision load is zero. On the other hand, in the case where the vehicle collides with an obstacle, the collision load of some degree is calculated by the calculation unit 23. Then, the calculation unit 23 determines whether or not the collision load is larger than or equal to 1000 kPa. In the case where the collision load is larger than or equal to 1000 kPa, a switching signal is sent to the signal selection unit 22.

At step S2, it is determined whether or not the switching signal is received by the signal selection unit 22. In the case where the switching signal is received, step S3 is performed. On the other hand, in the case where the switching signal is not received by the signal selection unit 22, the process shown in FIG. 9 will be repeated from step S1.

At step S3, the detection result of the A-type sensor cell 13 is selected (by signal selection unit 22 from detection results having been sent by mat-type pressure sensitive sensor 1) to be used as the signal which will be sent to the calculation unit 23. Moreover, at step S3, the detection result of the A-type sensor cell 13 is sent to the calculation unit 23.

Thereafter, the calculation unit 23 determines whether or not the collision load is smaller than 1000 kPa. In the case where the collision load is smaller than 1000 kPa, a switching signal will be sent to the signal selection unit 22.

At step S4, it is determined whether or not the switching signal is received by the signal selection unit 22. In the case where the switching signal is not received, step S3 is performed. On the other hand, in the case where the switching signal is received, the process shown in FIG. 9 will be repeated from the step S1.

Thus, as described above, each time the calculated collision load passes the value of 1000 kPa, for example, the calculated collision load becomes smaller than 1000 kPa or becomes lager than or equal to 1000 kPa again, the calculation unit 23 sends the switching signal to the signal selection unit 22.

In this case, every time the signal selection unit 22 receives the switching signal from the calculation unit 23, the signal to be sent to the calculation unit 23 is switched between the detection result of the B-type sensor cell 14 and that of the A-type sensor cell 13. That is, the above-described steps S1-S4 are repeated.

Moreover, the calculation unit 23 calculates the mass of the obstacle colliding with the vehicle based on the calculated collision load and the vehicle velocity detected by the vehicle velocity sensor 2, and sends the calculation result of the mass to the obstacle discrimination unit 24. In this case, the calculation of the mass of the obstacle colliding with the vehicle can be performed according to a manner described in JP-2005-156528A. According to this manner, the mass of the obstacle colliding with the vehicle is calculated, by using a once-integration value of the collision load and the vehicle velocity at the time of the collision.

The obstacle discrimination unit 24 sort-discriminates the obstacle colliding with the vehicle, based on the signal of the obstacle mass sent by the calculation unit 23. For example, it is determined that the obstacle is a pedestrian, in the case where the obstacle mass is within a predetermined range (having a lower limit and an upper limit). It is determined that the obstacle is a color cone or the like, in the case where the obstacle mass is smaller than the lower limit of the predetermined range. On the other hand, it is determined that the obstacle is a building or other vehicle or the like, in the case where the obstacle mass is larger than the upper limit of the predetermined range.

In the case where it is determined that the vehicle collides with the pedestrian, the obstacle discrimination unit 24 sends an actuation signal to the pedestrian protection device 21.

After the pedestrian protection device 21 received the actuation signal, for example, the hood of the vehicle is lifted, and/or the airbag for pedestrian is deployed on the hood. Thus, the impact to the pedestrian from the hood of the vehicle can be buffered.

According to this embodiment, the detection result which is detected in the high sensitivity field is selected from the detection result of the A-type sensor cell 13 and that of the B-type sensor cell 14, to be used for the calculation of the load which is in the required detection range to be detected (by mat-type pressure sensitive sensor 1) for discrimination of the pedestrian from other obstacle. Therefore, the detection accuracy can be improved. Accordingly, the collision obstacle discrimination device 10 can sort-discriminate the collision obstacle (specifically, determine whether or not collision obstacle is pedestrian) with a satisfactory accuracy.

Moreover, the multiple A-type sensor cells 13 and the multiple B-type sensor cells 14 which are mounted to the front surface of the reinforcement member 7 are alternately arranged, and positioned in the vicinity of each other. Thus, wherever the obstacle collides at the bumper 4 having the elongated shape in the vehicle left-right direction, the collision load can be substantially detected by the sensor cell 13, 14 in the high sensitivity field thereof.

Furthermore, in this embodiment, the mat-type pressure sensitive sensor 1 having the multiple sensor cells 13 and 14 is provided to detect the collision load. Because the mat-type pressure sensitive sensor 1 has the sensor cells 13 and 14 of the different types, the multiple sensitivity properties can be readily provided. Moreover, the multiple sensor cells 13 and 14 are provided in the single mat-typed pressure sensitive sensor 1 to be readily handled, for example, to be readily mounted to the vehicle, as compared with the case where the multiple sensor cells 13 and 14 are separately arranged.

### Other Embodiments

Although the present invention has been fully described in connection with the preferred embodiments thereof with reference to the accompanying drawings, it is to be noted that various changes and modifications will become apparent to those skilled in the art.

For example, in the above-described preferred embodiment, the calculation unit 23 sends the switching signal with the demarcation value (threshold value) of 1000 kPa. However, the demarcation value can be also suitably set as another value considering the property of the used sensor.

Furthermore, in the preferred embodiment, the signal selection unit 22 selects one of the sensor cell types, and then sends the detection result of the one type of the sensor cell to the calculation unit 23. However, the detection results of the multiple types of the sensor cells can be also sent to the calculation unit 23. In this case, the calculation unit 23 can selectively (or on a priority basis) use the detection result having a value in a predetermined range (in the case of preferable embodiment, detection result where electrical resistance is in the predetermined range is used).

Moreover, in the preferred embodiment, the A-type sensor cell 13 and the B-type sensor cell 14 are provided. However, the number of the sensor cell types can be also equal to or larger than three.

Moreover, in the preferred embodiment, the thickness H1 of the spacer film 18 of the A-type sensor cell 13 is substantially equal to the thickness H2 of the spacer film 18 of the B-type sensor cell 14. However, the thicknesses H1 and H2 can be respectively changed, so that the sensitivity properties of the A-type sensor cell 13 and the B-type sensor cell 14 become different from each other. Alternatively, at least one of the resin film 16, the spacer film 18 and the pressure sensitive ink layer 12 can be constructed of the different material with respect to the different type of sensor cell, so that the different type of sensor cell has the different sensitivity property.

Furthermore, in the preferred embodiment, the sensor cells 13 and 14 of the mat-type pressure sensitive sensor 1 are arrayed at the one row in the vehicle left-right direction. However, the sensor cells 13 and 14 of the mat-type pressure sensitive sensor 1 can be also arrayed at multiple rows in the vehicle left-right direction, or arrayed to cover the whole front surface of the reinforcement member 7.

Moreover, an optical fiber sensor can be also provided to detect the collision load, instead of the mat-type pressure sensitive sensor 1. In this case, the multiple optical fiber sensors which respectively have different sensitivity properties can be used. Alternatively, the single optical fiber sensor which has multiple sensitivity properties can be also used.

Furthermore, in the preferred embodiment, the sensor cells 13 and 14 are arranged between the reinforcement member 7 and the bumper absorber 8. Alternatively, the sensor cells 13 and 14 can be also arranged between the bumper cover 9 and the bumper absorber 8, for example.

Moreover, the mat-type pressure sensitive sensor 1 can be also attached to a rear portion (e.g., a rear bumper) of the vehicle, to detect a collision load applied to the vehicle due to a collision between the vehicle and an obstacle positioned at the rear side of the vehicle. Thus, the collision obstacle discrimination device can also sort-discriminate the obstacle of the vehicle rear side, based on the detection result of the collision load detection device (mat-type pressure sensitive sensor 1).

Such changes and modifications are to be understood as being in the scope of the present invention as defined by the appended claims.

What is claimed is:

1. A collision load detection device for a vehicle, comprising:
a plurality of load detection members for detecting a collision load applied to the vehicle due to a collision between the vehicle and an obstacle and outputting signals corresponding to the detected collision load; and
a controller for calculating the collision load in a predetermined load range based on the signals, wherein:
a sensitivity property of the load detection member includes a high sensitivity field in which the load detection member has a predetermined detection sensitivity in response to a variation of the collision load applied thereto, and a low sensitivity field in which the load detection member has a lower detection sensitivity than that of the high sensitivity field;
at least one of the plurality of load detection members has the sensitivity property different from that of the other of load detection members;
the predetermined load range is complementarily all-inclusive in the high sensitivity fields of the load detection members which have the different sensitivity properties; and
the controller selectively uses the signals detected in the high sensitivity field from the signals outputted by the plurality of load detection members, to calculate the collision load in the predetermined load range.

2. A collision load detection device for detecting a collision load applied to a vehicle due to a collision between the vehicle and an obstacle, comprising:
a first load detection member which has a high detection sensitivity when the collision load applied to the first load detection member is low, and which outputs a first signal in response to the collision load;
a second load detection member which has a high detection sensitivity when the collision load applied to the second load detection member is relatively high, and which outputs a second signal in response to the collision load; and
a controller which selectively uses the first signal and the second signal to calculate the collision load.

3. The collision load detection device according to claim 1, wherein:
the load detection member is a pressure-sensitive sensor cell; and
the plurality of sensor cells construct a mat-type pressure sensitive sensor.

4. The collision load detection device according to claim 2, wherein:
the load detection member is a pressure-sensitive sensor cell; and
the plurality of sensor cells construct a mat-type pressure sensitive sensor.

5. The collision load detection device according to claim 1, wherein
among the plurality of load detection members, the load detection members which have the different sensitivity properties are arranged adjacently to each other.

6. The collision load detection device according to claim 2, wherein
The first load detection member and the second load detection member which have the different sensitivity properties are arranged adjacently to each other.

7. The collision load detection device according to claim 1, wherein
the controller includes a signal selection unit which selects the signals detected in the high sensitivity field from the signals outputted by the plurality of load detection members, and a calculation unit which calculates the collision load by using the signals selected by the signal selection unit.

8. The collision load detection device according to claim 7, wherein
each time the collision load calculated by the calculation unit passes a demarcation value, the calculation unit sends a switching signal to the signal selection unit so that the signal to be used for the calculation of the collision load is switched between the signals of the load detection members having the different sensitivity properties.

9. A collision obstacle discrimination device having the collision load detection device according to claim 1, wherein
the controller sort-discriminates the obstacle, based on a detection result of the collision load detection device.

10. A collision obstacle discrimination device having the collision load detection device according to claim 2, wherein
the controller sort-discriminates the obstacle, based on a detection result of the collision load detection device.

11. The collision obstacle discrimination device according to claim 9, wherein
the controller further includes an obstacle discrimination unit which sort-discriminates the obstacle based on the detection result of the collision load detection device.

12. The collision obstacle discrimination device according to claim 11, further comprising
a velocity sensor for detecting a velocity of the vehicle, wherein
the obstacle discrimination unit sort-discriminates the obstacle, based on the detection result of the collision load detection device and that of the velocity sensor.
